(19) United States
(12) Patent Application Publication
(10) Pub. No.: US 2017/0322452 A1
(43) Pub. Date: Nov. 9, 2017

(54) DISPLAY DEVICE

(71) Applicant: SAMSUNG DISPLAY CO., LTD., Yongin-si (KR)

(72) Inventors: Luly LEE, Yongin-si (KR); Hyunwoo LEE, Anyang-si (KR); Hanmoe CHA, Seoul (KR); Donghoon KIM, Suwon-si (KR); Jungkyun KIM, Seoul (KR); Seokhyun NAM, Seoul (KR); Eunju NAM, Seoul (KR); Hyun-hwa SONG, Hwaseong-si (KR)

(21) Appl. No.: 15/584,248

(22) Filed: May 2, 2017

(30) Foreign Application Priority Data
May 4, 2016 (KR) 10-2016-0055578

(51) Int. Cl. G02F 1/1335; F21V 8/00; G02F 1/00

(52) U.S. Cl. CPC G02F 1/133606; G02F 1/133611; G02B 6/0073; G02F 1/133615; G02B 6/007; G02F 1/1336; G02F 1/0063; G02F 2001/133562; G02F 2001/133614

(57) ABSTRACT

A display device including a backlight unit and a display panel disposed on the backlight unit, wherein the backlight unit includes: a light source unit; and an optical unit, which is disposed between the light source unit and the display panel and includes an organic phosphor layer, the organic phosphor layer including an organic phosphor and a resin in which the organic phosphor is provided, and at least one face of the organic phosphor layer is exposed to air.

This application claims priority to Korean Patent Application No. 10-2016-0055578, filed on May 4, 2016, and all the benefits accruing therefrom under 35 U.S.C. §119, the content of which in its entirety is herein incorporated by reference.

### BACKGROUND

### (1) Field

The present invention relates to a display device, and more particularly, to a display device in which the display quality may be enhanced and the thickness of the display device may be reduced.

### (2) Description of the Related Art

Currently known display devices include liquid crystal display devices, plasma display devices, organic electroluminescent display devices, field effect display devices, and electrophoretic display devices.

Liquid crystal display devices include light receiving and light emitting elements which are incapable of self-emission utilize a separate light source. Recently, there has been an increased interest in the development of a display device that utilizes wavelength modifying materials, such as phosphors and quantum dots, to enhance the color and color reproducibility of the liquid crystal display device.

### SUMMARY

An object of the present disclosure is to provide a display device in which the display quality may be enhanced and the size of the display device may be slimmed down.

An embodiment provides a display device including a backlight unit and a display panel disposed on the backlight unit, wherein the backlight unit includes: a light source unit; and an optical unit, which is disposed between the light source unit and the display panel and includes an organic phosphor layer, wherein the organic phosphor layer includes an organic phosphor and a resin in which the organic phosphor is provided, and at least one face of the organic phosphor layer is exposed to air.

In an embodiment, the organic phosphor may include at least one compound displayed in Compound Group 1 below.

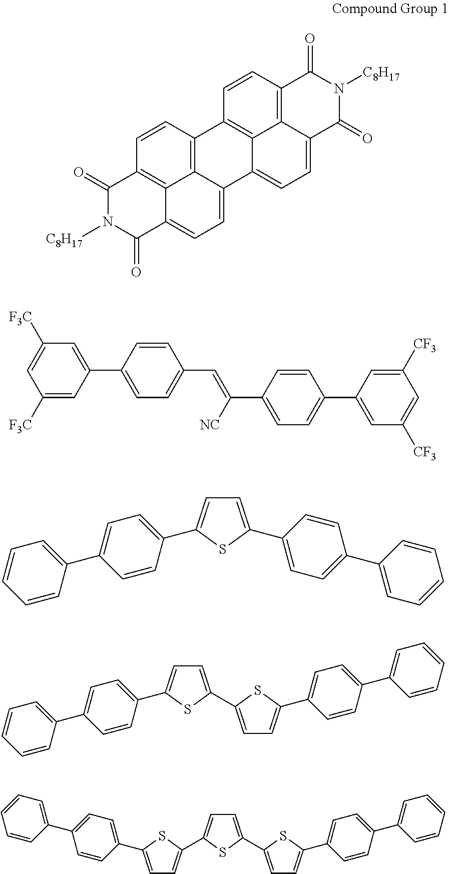

In an embodiment, the organic phosphor may include at least one selected from poly(9,9-dioctyl)fluorine, poly(9,9-di(ethylhexyl)fluorine), poly(9,9-dioctylfluorene-co-benzothiadiazole), and poly(9,9-dioctylfluorene-co-dithiophene).

In an embodiment, the optical unit may further include an accommodating part including an accommodating groove, wherein the organic phosphor layer is disposed in the accommodating groove.

In an embodiment, the organic phosphor layer may include a top face; a bottom face spaced apart from the top face; a first side face connected to each of the top face and the bottom face; a second side face connected to each of the top face and the bottom face, and spaced apart from the first side face; a third side face connected to each of the first side face and the second side face; and a fourth side face spaced apart from the third side face, wherein the top face is exposed to air and the bottom face, the first side face, the second side face, the third side face, and the fourth side face are concealed by the accommodating part.

In an embodiment, the accommodating part may include a floor part; and a plurality of side parts connected to the floor part, wherein the accommodating groove is defined by the floor part and the side parts, and the organic phosphor layer is disposed on the floor part.

In an embodiment, the optical unit may be formed of the organic phosphor layer, the organic phosphor layer including a top face; a bottom face spaced apart from the top face; a first side face connected to each of the top face and the bottom face; a second side face connected to each of the top face and the bottom face, and spaced apart from the first side face; a third side face connected to each of the first side face and the second side face; and a fourth side face spaced apart from the third side face, wherein each of the top face, the bottom face, the first side face, the second side face, the third side face, and the fourth side face are exposed to air.

In an embodiment, the optical unit may include a base substrate; and the organic phosphor layer is disposed on the base substrate.

In an embodiment, the organic phosphor layer may include a top face; a bottom face spaced apart from the top face; a first side face connected with each of the top face and the bottom face; a second side face connected to each of the top face and the bottom face, and spaced apart from the first side face; a third side face connected to each of the first side face and the second side face; and a fourth side face spaced apart from the third side face, wherein the top face, the first side face, the second side face, the third side face, and the fourth side face are exposed to air and the bottom face is concealed by the base substrate.

In an embodiment, the backlight unit may further include a light guide plate, which is configured to receive light from the light source unit, wherein the light source unit is disposed on a side face of the light guide plate and the optical unit is disposed between the light guide plate and the display panel.

In an embodiment, the backlight unit may further include a light guide plate, which is configured to receive light from the light source unit, wherein the light source unit is disposed on a side face of the light guide plate and the optical unit is disposed between the light source unit and the light guide plate.

In an embodiment, the backlight unit may further include a diffusion plate which is configured to receive light from the light source unit, wherein the light source unit is disposed below the diffusion plate and the optical unit is disposed between the light source unit and the diffusion plate.

### BRIEF DESCRIPTION OF THE DRAWINGS

FIG. 1 is a block diagram schematically illustrating a display device according to an embodiment;

FIGS. 2A, 2B, and 2C are perspective views schematically illustrating a display device according to an embodiment;

FIGS. 2D and 2E are cross-sectional views schematically illustrating an optical unit and a light source unit included in a display device according to an embodiment;

FIG. 3A is a perspective view schematically illustrating an optical unit included in a display device according to an embodiment;

FIG. 3B is a schematic cross-sectional view corresponding to line I-I′ in FIG. 3A, according to an embodiment;

FIG. 3C is a schematic cross-sectional view corresponding to II-II′ in FIG. 3A, according to an embodiment;

FIG. 4A is a schematic cross-sectional view corresponding to I-I′ in FIG. 3A, according to another embodiment;

FIG. 4B is a schematic cross-sectional view corresponding to II-II′ in FIG. 3A, according to another embodiment;

FIG. 5A is a schematic cross-sectional view corresponding to I-I′ in FIG. 3A, according to yet another embodiment; and

FIG. 5B is a schematic cross-sectional view corresponding to II-II′ in FIG. 3A, according to yet another embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In the drawings, like reference numerals refer to like elements. In the drawings, the dimensions of structures are shown enlarged. Although the terms first, second, etc. may be used herein to describe various elements, these elements should not be limited by these terms. These terms are only used to distinguish one element from another element. For example, a first element could be termed a second element, and likewise, a second element could be termed a first element without departing from the teachings. As used herein, singular forms are intended to include the plural forms as well, unless the context clearly indicates otherwise.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” It will be further understood that the terms “comprises” and/or “comprising,” or “includes” and/or “including”, when used in this specification, specify the presence of stated features, integers, steps, operations, elements, components, or combinations thereof, but do not preclude the presence or addition of one or more other features, integers, steps, operations, elements, components, or combinations thereof.

Moreover, it will be understood that when a part such as a layer, film, region, plate, etc. is referred to as being “on” another part, it can be directly on the other part, or one or more intervening layers, films, regions, plates, etc. may also be present. When a part such as a layer, film, region, plate, etc. is referred to as being “under” another part, it can be directly under, or one or more intervening layers, films, regions, plates, etc. may also be present.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

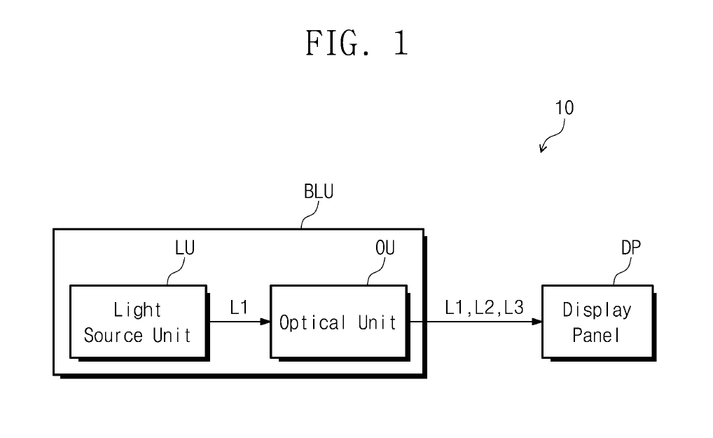

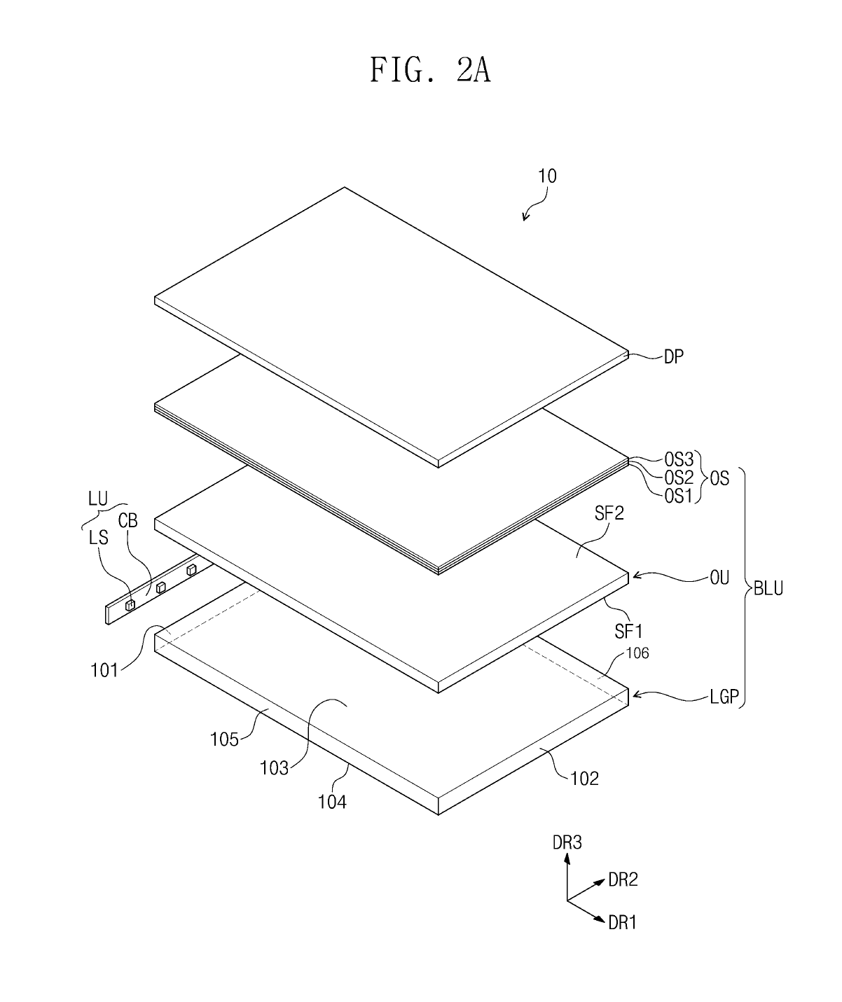

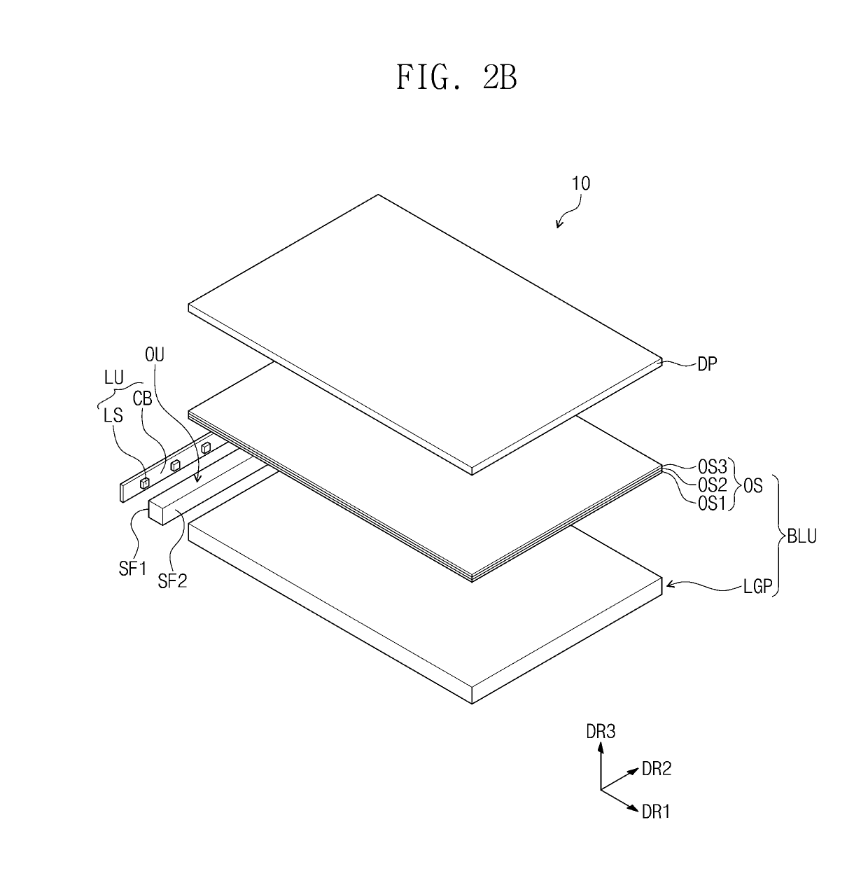

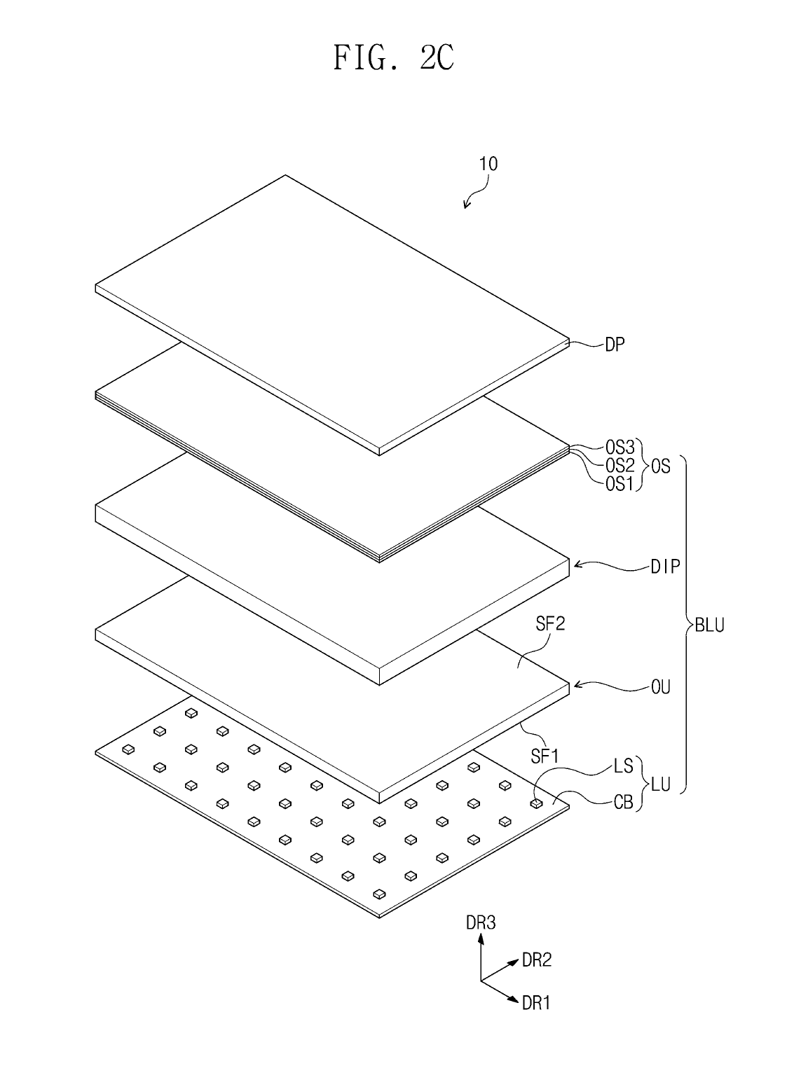

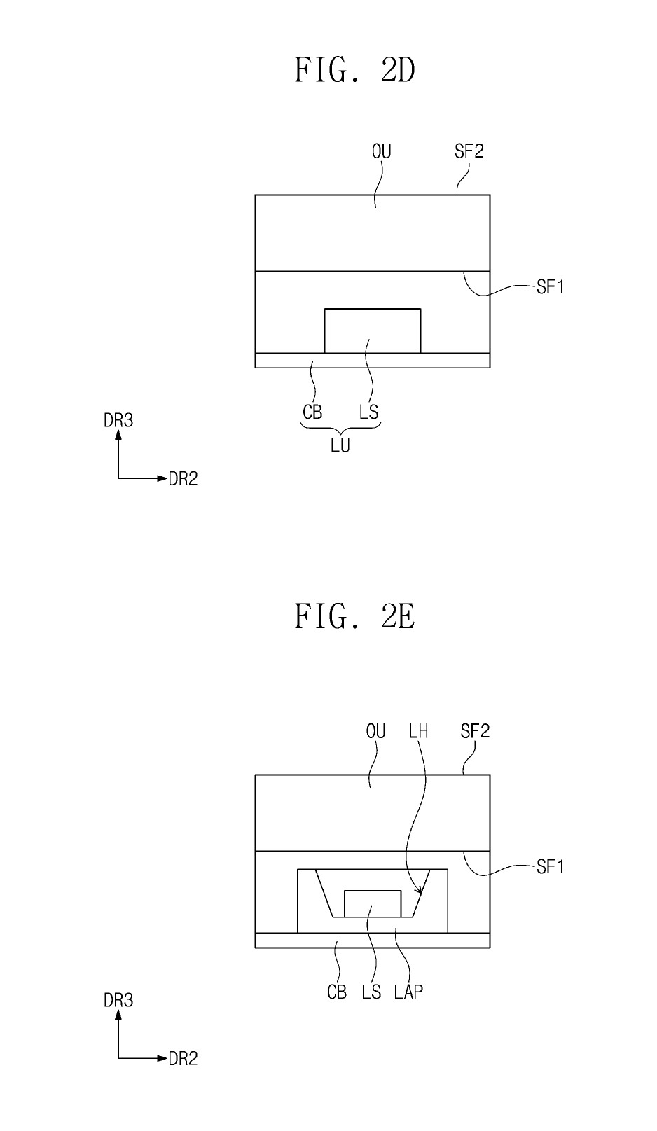

FIG. 1 is a block diagram schematically illustrating a display device according to an embodiment. FIGS. 2A, 2B, and 2C are perspective views schematically illustrating a display device according to an embodiment.

Referring to FIGS. 1, 2A, 2B, and 2C, a display device 10 according to an embodiment, includes a backlight unit BLU and a display panel DP provided on the backlight unit BLU. The backlight unit BLU and the display panel DP may be laminated in a third direction DR3.

The display panel DP is provided on the backlight unit BLU. The display panel DP receives light from the backlight unit and displays an image. The display panel DP is a light-receiving type display panel, and may be any of a variety of display panels including a liquid crystal display panel, a plasma display panel, an electrophoretic display panel, a microelectromechanical system (MEMS) display panel, and an electrowetting display panel. The display panel DP according to an embodiment is exemplarily described herein as a liquid crystal display panel.

The liquid crystal display panel may be a panel which operates in any one of a vertical alignment (VA) mode, a patterned vertical alignment (PVA) mode, an in-plane switching (IPS) mode, a fringe-field switching (FFS) mode, or a plane to line switching (PLS) mode, and is not limited to a panel of a particular mode.

The backlight unit BLU provides light to the display panel DP. The backlight unit BLU includes a light source unit LU and an optical unit OU. The light source unit LU provides a first light L1 to the optical unit OU. For example, the light source unit LU may provide a blue light. The light source unit LU may include at least one light source LS and a circuit board CB on which the light source is disposed and which supplies power to the light source LS. The light source LS may be, for example, a light emitting diode (LED). The backlight unit BLU may include a single light source LS or there may be a plurality of light sources LS spaced apart in a second direction DR2 on the circuit board CB. The light source LS may emit, for example, a blue light.

The optical unit OU receives the first light from the light source unit LU, converts at least a portion of the first light L1 into a second light L2 and a third light L3 having different colors from the first light L1, and linearly polarizes the converted light. For example, the first light L1 may be a blue light, the second light L2 may be a green light, and the third light L3 may be a red light. The optical unit OU the first light L1, the second light L2, and the third light L3 to the display panel provides DP.

The optical unit OU includes a bottom face SF1 and a top face SF2. The optical unit OU may receive the first light L1 from the light source unit LU through the bottom face SF1. The top face SF2 may be positioned closer to the display panel DP than the bottom face SF1. The optical unit OU may provide the first light L1, the second light L2, and third light L3 to the display panel DP through the top face SF2. The optical unit OU will be described later in more detail.

The backlight unit BLU may further include an optical sheet OS. The optical sheet OS improves the brightness and viewing angle of light provided to the display panel DP. The optical sheet OS may include a first optical sheet OS1, a second optical sheet OS2, and a third optical sheet OS3, which are sequentially laminated.

The first optical sheet OS1 may be a diffusion sheet that diffuses light provided to the display panel DP. The second optical sheet OS2 may be a prism sheet that focuses the light diffused by the diffusion sheet in a direction perpendicular to the plane of the display panel DP. The third optical sheet OS3 may be a protective sheet that protects the prism sheet from external impact. The optical sheet OS may be prepared by overlapping the first optical sheet OS1, the second optical sheet OS2, and/or the third optical sheet OS3, and one or more of the sheets may also be excluded as desired.

Although not shown, the display device 10 according to an embodiment may further include a bottom chassis. The bottom chassis may be disposed below the backlight unit BLU. The bottom chassis may store elements of the backlight unit BLU and the display panel DP.

Although not shown, the display device according to an embodiment may further include a mold frame. The mold frame may be provided between the display panel DP and the backlight unit BLU. The mold frame may be provided along the edges of the display panel DP and support the display panel DP from below. The mold frame may be provided separate from the bottom chassis, or may be integrated with the bottom chassis.

Referring to FIGS. 2A and 2B, the display device 10 according to an embodiment may include an edge-type light source unit. The backlight unit BLU may further include a light guide plate LGP. The light guide plate LGP may be provided below the display panel DP.

The light guide plate LGP may guide and emit light provided from the light source unit LU. The light guide plate LGP may direct light received from the light source unit LU toward the display panel DP. Light incident to the inside of the light guide plate LGP is emitted toward the display panel DP through a light emitting face 103. The light guide plate LGP includes a light incident face 101, a light facing face 102, the light emitting face 103, a rear face 104, a first side face 105, and a second side face 106.

The light incident face 101 receives the light emitted from the light source unit LU. The light incident face 101 is adjacent to the light source unit LU. The light incident face 101 is connected to the light emitting face 103, the rear face 104, the first side face 105, and the second side face 106. The light incident face 101 faces the light facing face 102.

The light facing face 102 faces the light incident face 101. The light facing face 102, may be spaced apart from the light incident face 101 in, for example, a first direction DR1. The light facing face 102 is connected to the light emitting face 103, the rear face 104, the first side face 05, and the second side face 106.

The light emitting face 103 emits light provided from the light incident face 101. The light emitting face 103 is adjacent to the display panel DP. The light emitting face 103 is connected to the light incident face 101, the light facing face 102, the first side face 105, and the second side face 106. The light emitting face 103 faces the rear face 104.

The rear face 104 faces the light emitting face 103. The rear face 104 may be spaced apart DR3 from the light emitting face 103 in, for example, the third direction. The rear face 104 is connected to the light incident face 101, the light facing face 102, the first side face 105, and the second side face 106.

The first side face 105 is connected to the light incident face 101, the light facing face 102, the light emitting face 103, and the rear face 104. The second side face 106 may be spaced apart in the second direction DR2 from the first side face 105. The second side face 106 is connected to the light incident face, the light facing face 102, the light emitting face 103, and the rear face 104.

A type of the light guide plate LGP which is used may be without particular limit, and the light guide plate LGP may include a polymer resin or glass. The polymer resin may include, for example, a transparent polymer resin such as polycarbonate, polymethyl methacrylate, polydimethylsiloxane, polystyrene, methacrylate styrene, or a combination thereof.

Although not shown, the light guide plate LGP may include an optical pattern. The optical pattern may totally reflect light. For example, the optical pattern may be disposed on at least one of the light emitting face and the rear face facing the light emitting face.

Although not shown, the backlight unit BLU may further include a reflective sheet. The reflective sheet may be provided below the light guide plate LGP. By reflecting light that has leaked out from the light source instead of traveling toward the display panel DP, the reflective sheet may change the path of the light so that the light travels toward the display panel DP. Accordingly, the reflective sheet increases the amount of light provided toward the display panel DP.

In FIGS. 2A and 2B, the light source unit LU is exemplarily illustrated disposed on one of the narrower sides of the light guide plate LGP, but the position of the light source unit LU is not limited thereto, and may also be disposed on one of the wider sides of the light guide plate LGP.

In FIGS. 2A and 2B, the light source unit LU is exemplarily illustrated as being disposed on only one side of the light guide plate LGP, but the position of the light source unit LU is not limited thereto, and one light source unit LU or multiple light source units LU may be disposed along any one or more of the other sides of the light guide plate LGP.

Referring to FIG. 2A, the optical unit OU may be provided between the light guide plate LGP and the display panel DP. The optical unit OU may be provided on the light emitting face 103 of the light guide plate LGP. The top face SF2 of the optical unit OU may face the display panel DP, and the bottom face SF1 of the optical unit OU may face the light emitting face 103 of the light guide plate LGP.

Referring to FIG. 2B, the optical unit OU may be provided between the light source unit LU and the light guide plate LGP. The top face SF2 of the optical unit OU may face the light incident face 101 of the light guide plate LGP, and the bottom face SF1 of the optical unit OU may face the light source unit LU.

Referring to FIG. 2C, the display device 10 according to an embodiment may include a direct-type light source unit LU. The backlight unit BLU may further include a diffusion plate DIP. The diffusion plate DIP may receive light from the optical unit LU and provide light to the display panel DP. The optical unit OU may be provided between the diffusion plate DIP and the light source unit LU.

FIGS. 2D and 2E are cross-sectional views schematically illustrating an optical unit and a light source unit included in a display device according to an embodiment.

As illustrated in FIG. 2D, a light source unit LU may include a circuit board CB and a light source LS provided on the circuit board CB and in contact with the circuit board CB, and as illustrated in FIG. 2E, the light source unit LU may include a circuit board CB, a light source accommodating body LAP provided on the circuit board CB, and a light source LS disposed in the light source accommodating body LAP. The light source accommodating body LAP may include a light source accommodating groove LH, and the light source LS may be disposed within the light source accommodating groove LH.

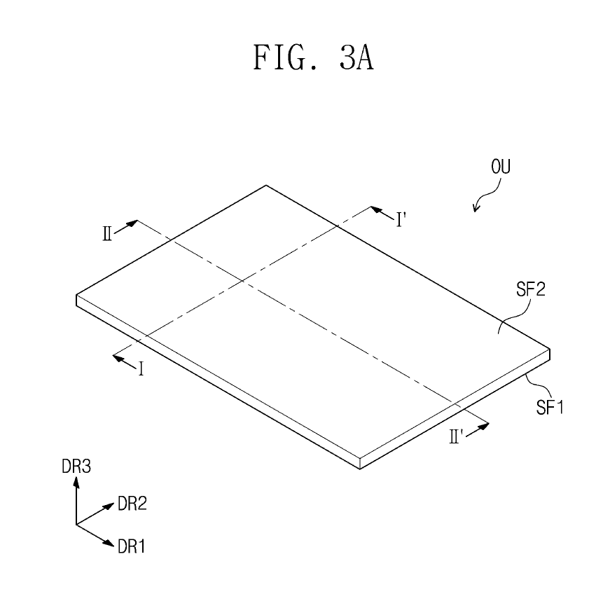

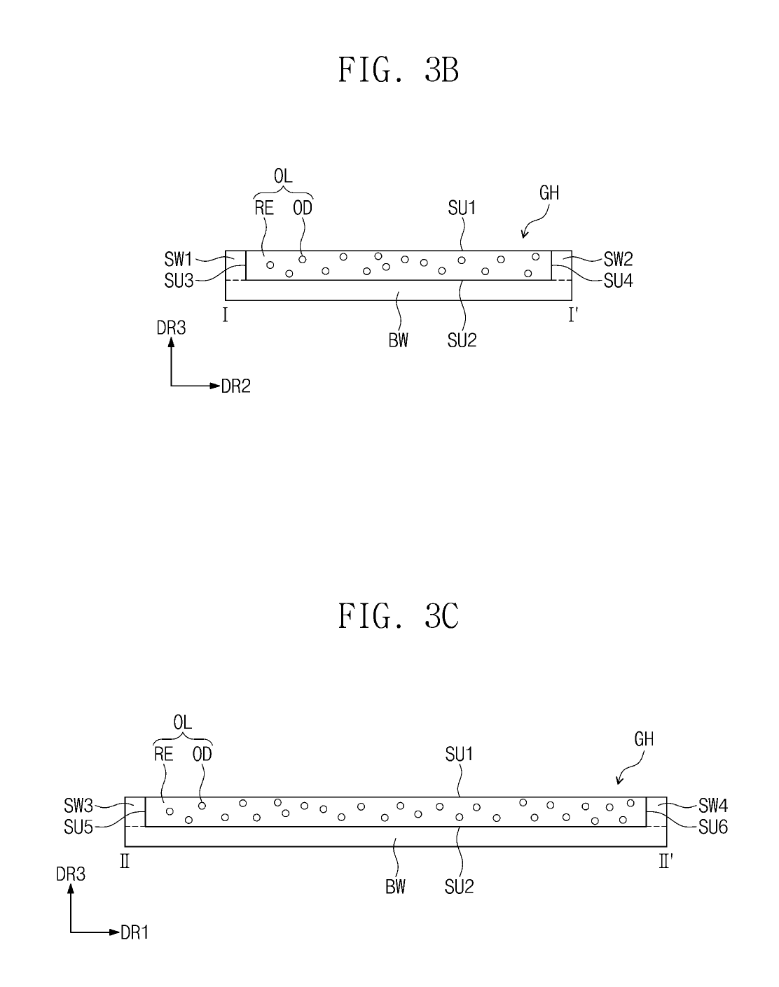

FIG. 3A is a perspective view schematically illustrating an optical unit included in a display device according to an embodiment. FIG. 3B is a schematic cross-sectional view corresponding to I-I′ in FIG. 3A, according to an embodiment. FIG. 3C is a schematic cross-sectional view corresponding to II-II′ in FIG. 3A, according to an embodiment.

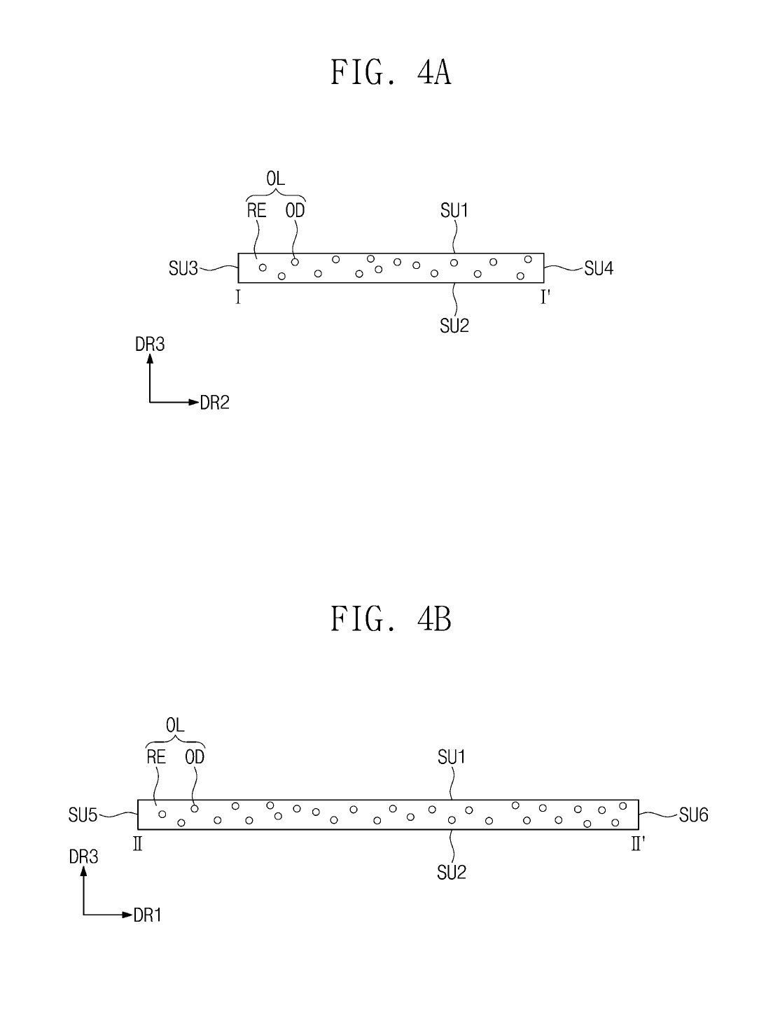

FIG. 4A is a schematic cross-sectional view corresponding to I-I′ in FIG. 3A, according to another embodiment. FIG. 4B is a schematic cross-sectional view corresponding to II-II′ in FIG. 3A, according to another embodiment.

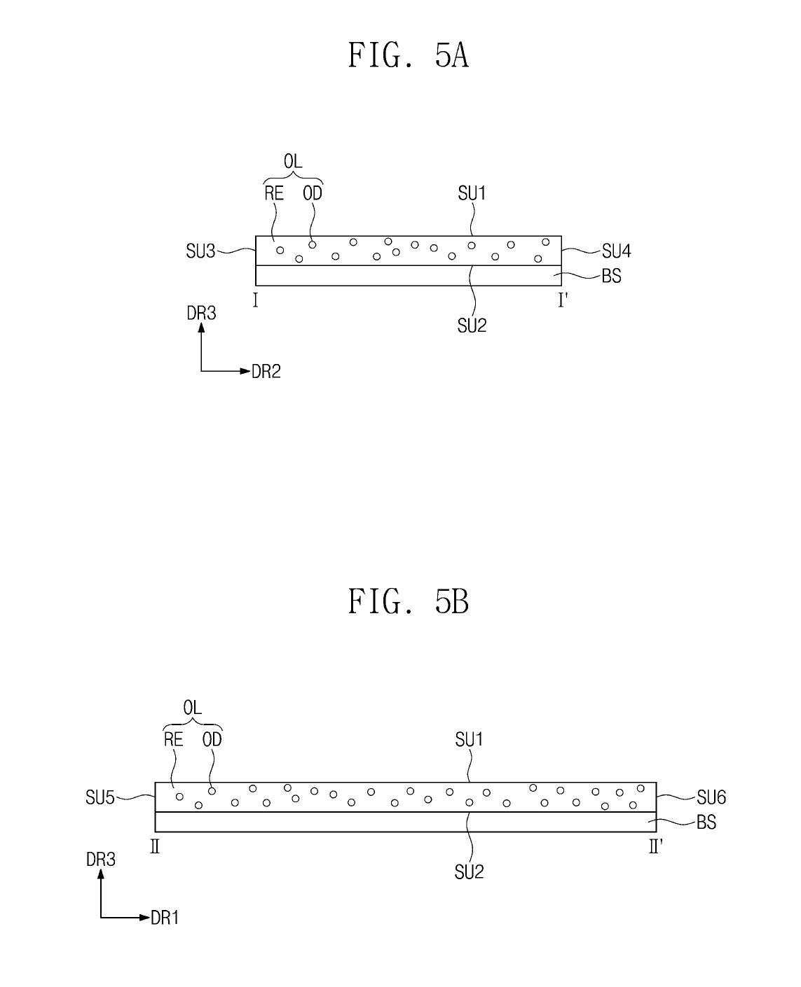

FIG. 5A is a schematic cross-sectional view corresponding to I-I′ in FIG. 3A, according to yet another embodiment. FIG. 5B is a schematic cross-sectional view corresponding to II-II′ in FIG. 3A, according to yet another embodiment.

Referring to FIGS. 3A to 3C, 4A, 4B, 5A, and 5B, an optical unit OU includes an organic phosphor layer OL. At least one side of the organic phosphor layer OL may be exposed to air.

The organic phosphor layer OL includes a top face SU1, a bottom face SU2, a first side face SU3, a second side face SU4, a third side face SU5, and a fourth side face SU6. The top face SU1 of the organic phosphor layer OL may be at least a portion of the top face SF2 of the optical unit OU. The top face SU1 of the organic phosphor layer OL is spaced apart from the bottom face SU2 of the organic phosphor layer OL in, for example, the third direction DR3.

The bottom face SU2 of the organic phosphor layer OL is spaced apart from the top face. The bottom face SU2 of the organic phosphor layer OL may be at least a portion of the bottom face SF1 of the optical unit OU. The bottom face SU2 of the organic phosphor layer OL is connected to each of the first side face SU3, the second side face SU4, the third side face SU5, and the fourth side face SU6.

The first side face SU3 is connected to each of the top face SU1 of the organic phosphor layer OL and the bottom face SU2 of the organic phosphor layer OL. The second side face SU4 is spaced apart from the first side face SU3. The second side face SU4 is spaced apart from the first side face SU3 in, for example, the second direction DR2. The second side face SU4 is connected to each of the top face SU1 of the organic phosphor layer OL and the bottom face SU2 of the organic phosphor layer OL. The third side face SU5 is connected to the first side face SU3 and the second side face SU4. The third side face SU5 is connected to each of the top face SU1 of the organic phosphor layer OL and the bottom face SU2 of the organic phosphor layer OL. The fourth side face SU6 is spaced apart from the third side face SU5. The fourth side face SU6 is spaced apart from the third side face SU5 in, for example, the first direction DR1. The fourth side face SU6 is connected to each of the top face SU1 of the organic phosphor layer OL and the bottom face SU2 of the organic phosphor layer OL.

The organic phosphor layer OL includes an organic phosphor OD and a resin RE. The organic phosphor OD may be an organic material which emits light by being excited by light.

The type of organic phosphor OD which may be used is without particular limit, and may include at least one of the compounds displayed in Compound Group 1 below.

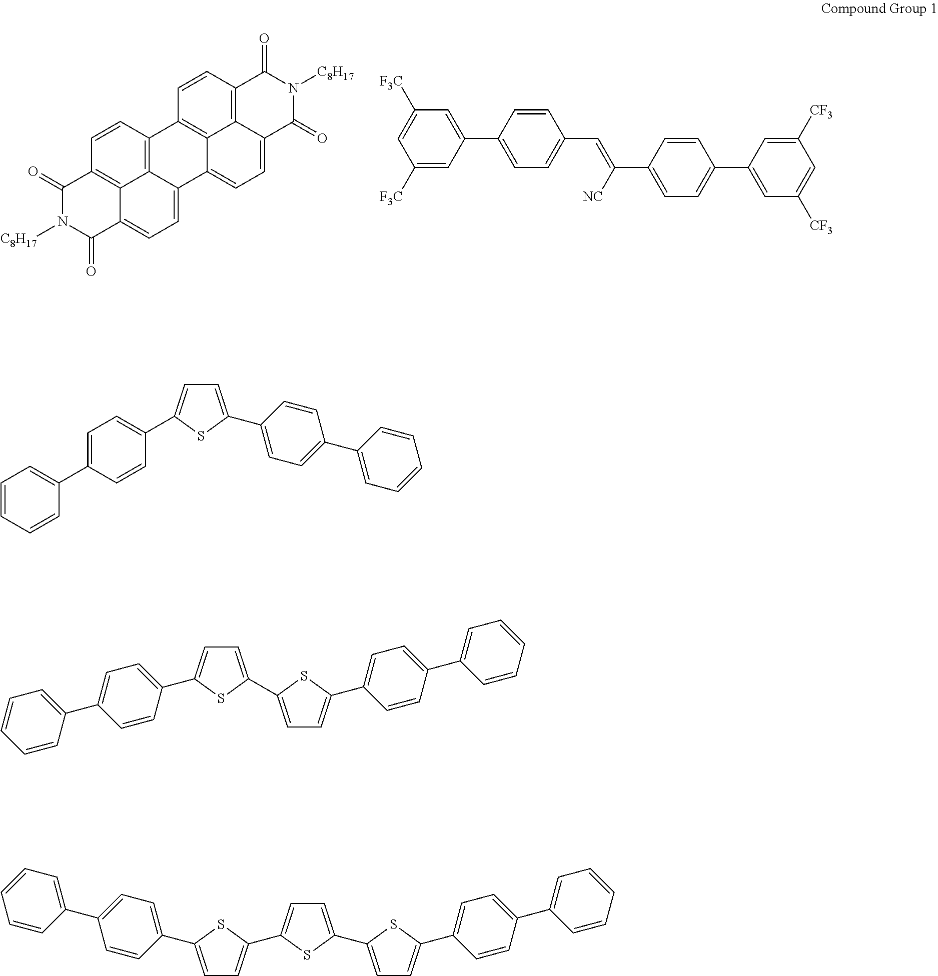

The organic phosphor OD may include at least one selected from, for example, poly(9,9-dioctyl)fluorine, poly(9,9-di(ethylhexyl)fluorine), poly(9,9-dioctylfluorene-co-benzothiadiazole), and poly(9,9-dioctylfluorene-co-dithiophene).

The resin RE is provided with the organic phosphor OD. The organic phosphor OD may be randomly dispersed in the resin RE. The type of resin RE used may be without particular limit, and may include, for example, a silicon resin or a photosensitive resin. The resin RE may include at least one selected from, for example, a monomer or an oligomer. The organic phosphor layer OL may further include at least one selected from a UV initiator, a diffusing agent, a defoamer, and a scattering member.

Referring to FIGS. 3A to 3C, the optical unit OU may include an accommodating part BW, SW1, SW2, SW3, and SW4 and the organic phosphor layer OL. The accommodating part BW, SW1, SW2, SW3, and SW4 includes a floor part BW and side parts SW1, SW2, SW3, and SW4. The side parts SW1, SW2, SW3, and SW4 include a first side part SW1, a second side part SW2, a third side part SW3, and a fourth side part SW4.

The floor part BW is in contact with the organic phosphor layer OL. The first side part SW1 is connected to the floor part BW. The second side part SW2 is spaced apart from the first side part SW1. The second side part SW2 may be spaced apart from the first side part SW1 in, for example, the second direction DR2. The second side part SW2 is connected to the floor part BW. The third side part SW3 is connected to the first side part SW1 and the second side part SW2. The third side part SW3 is connected to the floor part BW. The fourth side part SW4 is spaced apart from the third side part SW3. The fourth side part SW4 is spaced apart from the third side part SW3 in, for example, the first direction DR1. The fourth side part SW4 is connected to the first side part SW1 and the second side part SW2. The fourth side part SW4 is connected to the floor part BW.

The accommodating part BW, SW1, SW2, SW3, and SW4 is equipped with an accommodating groove GH. The organic phosphor layer OL is accommodated in the accommodating groove GH. The accommodating groove GH is defined by the floor part BW and the side parts SW1, SW2, SW3, and SW4. More specifically, the accommodating groove GH may be defined by the floor part BW, the first side part SW1, the second side part SW2, the third side part SW3, and the fourth side part SW4. The accommodating groove GH may indicate a space defined by a region between, for example, the floor part BW, the first side part SW1, the second side part SW2, the third side part SW3, and the fourth side part SW4.

Referring to FIGS. 3A to 3C, the top face SU1 of the organic phosphor layer OL is exposed to air. Each of the bottom face SU2, the first side face SU3, the second side face SU4, the third side face SU5, and the fourth side face SU6 of the organic phosphor layer OL is concealed by the accommodating part BW, SW1, SW2, SW3, and SW4. That is, in FIGS. 3A to 3C, none of the first side face SU3, the second side face SU4, the third side face SU5, and the fourth side face SU6 of the organic phosphor layer OL are exposed to air.

Referring to FIGS. 3A, 4A, and 4B, the optical unit OU may be formed of the organic phosphor layer OL. For example, the organic phosphor layer OL itself may be the optical unit OU. Here, each of the top face SU1 of the organic phosphor layer OL, the bottom face SU2 of the organic phosphor layer OL, the first side face SU3, the second side face SU4, the third side face SU5, and the fourth side face SU6 may be exposed to air.

Referring to FIGS. 3A, 5A, and 5B, the optical unit OU may include a base substrate BS and the organic phosphor layer OL. The type of base substrate BS used may be without particular limit, and may include, for example, a plastic or an organic polymer, and the like. Organic polymers forming the base substrate BS may include polyethylene terephthalate (PET), polyethylene naphthalate (PEN), polyimide, etc., or a combination thereof.

The organic phosphor layer OL may be provided on the base substrate BS. Here, each of the top face SU1 of the organic phosphor layer OL, the first side face SU3, the second side face SU4, the third side face SU5, and the fourth side face SU6 may be exposed to air. The bottom face SU2 of the organic phosphor layer OL may be concealed by the base substrate BS. That is, in FIGS. 5A, and 5B, the bottom face SU2 of the organic phosphor layer OL may not be exposed to air

In display devices which include quantum dot- or quantum rod-containing optical units, it is important that a layer containing the quantum dots or quantum rods is not exposed to air. This is because the quantum dots and quantum rods bond with oxygen and lose electrons when exposed to air. Further, when quantum dots and quantum rods are included in the display device, a lamination operation with a separate barrier film and the like, is not possible. Moreover, quantum dots that contain heavy metals such as cadmium (Cd) are considered to be carcinogens and thus are detrimental to the human body. In the display device according to embodiments described herein, since organic phosphors are used instead of quantum dots, the reliability of the display device may be maintained even when a portion (e.g., one or more sides) of the organic phosphor layer is exposed to air. Moreover, since a separate member for sealing the organic phosphor layer is not included, it is possible to reduce the thickness of the display device and thus slimming of the display device is easily achieved. Furthermore, the display device according to embodiments excludes heavy metals such as Cd, and thus does not include a material which is known to cause cancer.

Accordingly, as described herein with reference to various embodiments, a display device having improved display quality and reduced thickness may be prepared

Although exemplary embodiments of the present disclosure have been described, it is understood that the present invention should not be limited to these exemplary embodiments but various changes and modifications can be made by one ordinary skilled in the art within the technical spirit and scope of the present invention. Thus, the technical embodiments described above are in every way exemplary, and shall not be construed to be limiting.

What is claimed is:

1. A display device comprising,
a backlight unit; and
a display panel disposed on the backlight unit, wherein the backlight unit comprises:
a light source unit; and
an optical unit, which is disposed between the light source unit and the display panel and comprises an organic phosphor layer,
wherein the organic phosphor layer comprises an organic phosphor and a resin in which the organic phosphor is provided, and at least one face of the organic phosphor layer is exposed to air.

2. The display device of claim 1, wherein the organic phosphor comprises at least one compound displayed in Compound Group 1 below.

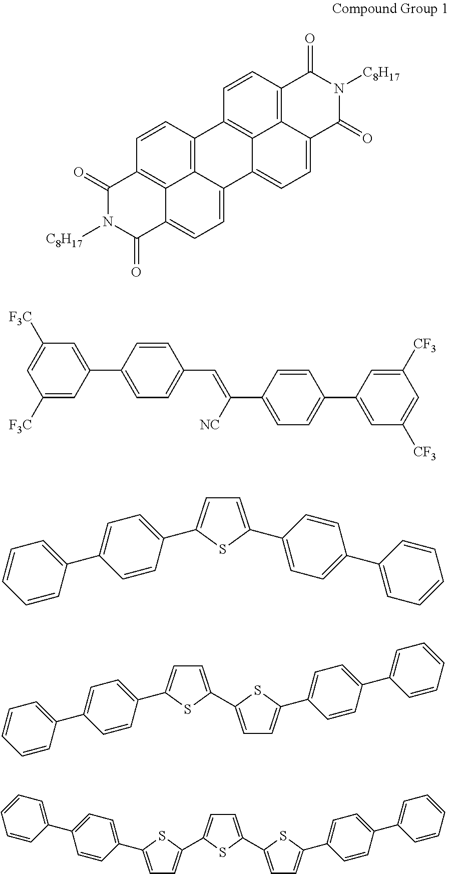

3. The display device of claim 1, wherein the organic phosphor comprises at least one selected from poly(9,9-dioctyl)fluorine, poly(9,9-di(ethylhexyl)fluorine), poly(9,9-dioctylfluorene-co-benzothiadiazole), and poly(9,9-dioctylfluorene-co-dithiophene).

4. The display device of claim 1, wherein the optical unit further comprises an accommodating part comprising an accommodating groove, wherein the organic phosphor layer is disposed in the accommodating groove.

5. The display device of claim 4, wherein the organic phosphor layer comprises:
a top face;
a bottom face spaced apart from the top face;
a first side face connected to each of the top face and the bottom face;
a second side face connected to each of the top face and the bottom face, and spaced apart from the first side face;
a third side face connected to each of the first side face and the second side face; and
a fourth side face spaced apart from the third side face,
wherein the top face is exposed to air and the bottom face, the first side face, the second side face, the third side face, and the fourth side face are concealed by the accommodating part.

6. The display device of claim 4, wherein the accommodating part comprises:
a floor part; and
a plurality of side parts connected to the floor part,
wherein the accommodating groove is defined by the floor part and the plurality of side parts, and the organic phosphor layer is disposed on the floor part.

7. The display device of claim 1, wherein the optical unit is formed of the organic phosphor layer, the organic phosphor layer comprising:
a top face;
a bottom face spaced apart from the top face;
a first side face connected to each of the top face and the bottom face;
a second side face connected to each of the top face and the bottom face, and spaced apart from the first side face;
a third side face connected to each of the first side face and the second side face; and
a fourth side face spaced apart from the third side face,
wherein each of the top face, the bottom face, the first side face, the second side face, the third side face, and the fourth side face are exposed to air.

8. The display device of claim 1, wherein the optical unit comprises:
a base substrate; and
the organic phosphor layer is disposed on the base substrate.

9. The display device of claim 8, wherein the organic phosphor layer comprises:
a top face;
a bottom face spaced apart from the top face;
a first side face connected to each of the top face and the bottom face;
a second side face connected to each of the top face and the bottom face, and spaced apart from the first side face;
a third side face connected to each of the first side face and the second side face; and
a fourth side face spaced apart from the third side face,
wherein the top face, the first side face, the second side face, the third side face, and the fourth side face are exposed to air and the bottom face is concealed by the base substrate.

10. The display device of claim 1, wherein the backlight unit further comprises a light guide plate, which is configured to receive light from the light source unit, wherein the light source unit is disposed on a side face of the light guide plate and the optical unit is disposed between the light guide plate and the display panel.

11. The display device of claim 1, wherein the backlight unit further comprises a light guide plate, which is configured to receive light from the light source unit, wherein the light source unit is disposed on a side face of the light guide plate and the optical unit is disposed between the light source unit and the light guide plate.

12. The display device of claim 1, wherein the backlight unit further comprises a diffusion plate, which is configured to receive light from the light source unit, wherein the light source unit is disposed below the diffusion plate and the optical unit is between the light source unit and the diffusion plate.
